(19) United States
(12) Patent Application Publication
(10) Pub. No.: US 2004/0165796 A1
(43) Pub. Date: Aug. 26, 2004

(54) Linear bearing assembly with adjustable bearing pad

(76) Inventor: Kory W. Longhurst, North Ogden, UT (US)

Correspondence Address: TRASK BRITT, P.O. BOX 2550, SALT LAKE CITY, UT, 84110, US

(21) Appl. No.: 10/740,691

(22) Filed: Dec. 18, 2003

Related U.S. Application Data
(60) Provisional application No. 60/435,899, filed on Dec. 20, 2002.

(51) Int. Cl. F16C 29/12; F16C 33/00

(52) U.S. Cl. 384/40; 384/42

(57) ABSTRACT

A linear bearing assembly including a bearing slide with a multiple-sided cavity, such as a U-shaped cavity, with at least one bearing pad mounted to each wall thereof is disclosed. Each bearing pad may be adjustably secured with respect to a wall of the cavity with one or more retention members and one or more adjustment elements carried by the bearing slide and cooperating with the bearing pad. A method of adjusting bearing pad fit and a method of adjusting abutting force to a bearing pad in a linear bearing assembly are also disclosed.

### RELATED APPLICATIONS

This application claims the benefit of U.S. Provisional Patent Application Serial No. 60/435,899, filed Dec. 20, 2002, for LINEAR BEARING ASSEMBLY WITH ADJUSTABLE BEARING PAD FIT.

### BACKGROUND OF THE INVENTION

1. Field of the Invention

The present invention relates to linear bearing assemblies and, more particularly, to linear bearing assemblies including an adjustable bearing pad position.

2. State of the Art

Linear bearing assemblies are employed to provide guided linear motion. A linear bearing assembly may carry, or have attached thereto, some structure to be moved linearly between two or more locations along a guide rail. Alternatively, the linear bearing assembly may be fixed in position and the guide rail carrying a structure moved with respect to the linear bearing assembly. Of course, the use of multiple, parallel guide rails and more than one linear bearing assembly per guide rail are common.

Currently, it is conventional to use aluminum extrusions as guide rails and a multiple sided bearing housing or “slide” defining a three-sided cavity in which the guide rail is disposed. Each wall of the cavity of the bearing slide defining a side of the cavity carries a bearing or bearing pad of a relatively low friction material for contacting a side of the guide rail, the bearing slide and pads together forming a linear bearing assembly.

It is important that the outer face of each bearing pad be snugly, but slidably, abutting a side of the guide rail to promote a smooth, controlled linear motion between the linear bearing assembly and the guide rail while avoiding lateral motion and, when multiple linear bearing assemblies are associated with a guide rail, offsetting or cocking of one linear bearing assembly with respect to the other and consequent uneven wear, nonlinear travel and pinching of the guide rail as the linear bearing assemblies become mutually skewed. Misalignment between a linear bearing assembly and its associated guide rail will eventually become a problem with any such arrangement, as the bearing pad is typically formed of a low friction, and relatively soft material such as ultra-high molecular weight polyethylene.

To maintain a desired spatial relationship between a linear bearing assembly and its associated guide rail as bearing pads wear, shims are conventionally disposed between a side wall or an end (horizontal) wall of the bearing slide and the bearing pad disposed on that side. As the bearing pad continues to wear, thicker shims, multiple stacked shims, or both, are inserted. This approach, while effective, is time consuming and may require significant trial and error shim insertion and removal until the correct shim thickness, or combination of stacked shims providing appropriate thickness, is selected. Of course, use of shims may also require that the operator of the structure including the linear bearing assemblies obtain or stock a shim set for each side of each bearing slide with a bearing pad so that both vertical and horizontal clearances may be maintained. Thus, one may need to repeatedly shim a bearing pad at one side wall of the bearing slide cavity to maintain a side-to-side snug fit between opposing vertically oriented bearing pads. Similarly, as the bearing pad carried on a horizontal wall of a bearing slide wears, it is necessary to shim between that bearing pad and the bearing slide to maintain a constant vertical relationship between the guide rail and the bearing slide. For some high dimensional tolerance applications, shimming may not be required as frequently as in other, low dimensional tolerance applications, but bearing pad wear and the inconvenience of conventional shimming techniques eventually become a problem for most applications. In the case of extremely low tolerance applications, it may be necessary to shim both vertically oriented bearing pads to maintain the guide rail centered within the bearing slide.

It would be desirable to provide a linear bearing with an adjustable bearing pad assembly which does not require the use of shims or other consumable components other than the bearing pads themselves.

### BRIEF SUMMARY OF THE INVENTION

The present invention comprises a linear bearing assembly with a self-contained adjustment structure for a bearing pad. The linear bearing assembly may include a bearing slide with a multiple-sided cavity, such as a U-shaped cavity, further including at least one bearing pad mounted to each wall thereof. Each bearing pad may be adjustably secured with respect to a wall of the cavity with one or more retention members and one or more adjustment elements carried by the bearing slide and cooperating with the bearing pad. Accordingly, adjusting a position of at least one bearing pad relative to the wall to which the at least one bearing pad is secured may be accomplished by way of the at least one adjustment element carried by the bearing slide.

In one exemplary embodiment one or more, and preferably two, retention elements in the form of retention bolts extend from a counterbore in the exterior of the bearing wall, into and through the wall defining the cavity side and into a threaded bore within the bearing pad. An adjustment element in the form of a set screw associated with each retention bolt also extends from an aperture in the wall and contacts the rear face of the bearing pad. In addition, the adjustment element may comprise a biasing element such as a spring. If ultra-high molecular weight polyethylene bearing pads are employed, tee-nuts including the threaded bore may be embedded in the bearing pads to prevent bearing pad tear-out under loading, and a rigid stiffener or backing plate may be bonded to the rear face of the bearing pad.

To adjust the bearing pad location with respect to the wall, the retention bolts may be loosened incrementally to release the bearing pad toward the guide rail and then the set screws driven or advanced forward until tight against the rear face of the bearing pad. Additionally, in the same way, a force that abuts the bearing pad against the side of a guide rail may be selectively adjusted. For instance, a force that abuts the bearing pad against the side of the guide rail may be selectively adjusted by loosening the retention bolts, advancing the set screws, and tightening the retention bolts. Also, a biasing element may be adjusted in order to selectively adjust a force that abuts the bearing pad against the side of the guide rail.

### BRIEF DESCRIPTION OF THE DRAWINGS

FIG. 1 is a frontal elevation of an exemplary linear bearing assembly according to the present invention with a guide rail disposed therein;

FIG. 2 is a side elevation of the exemplary linear bearing assembly of FIG. 1; and

FIG. 3 is a top elevation of the exemplary linear bearing assembly of FIG. 1.

### DETAILED DESCRIPTION OF THE INVENTION

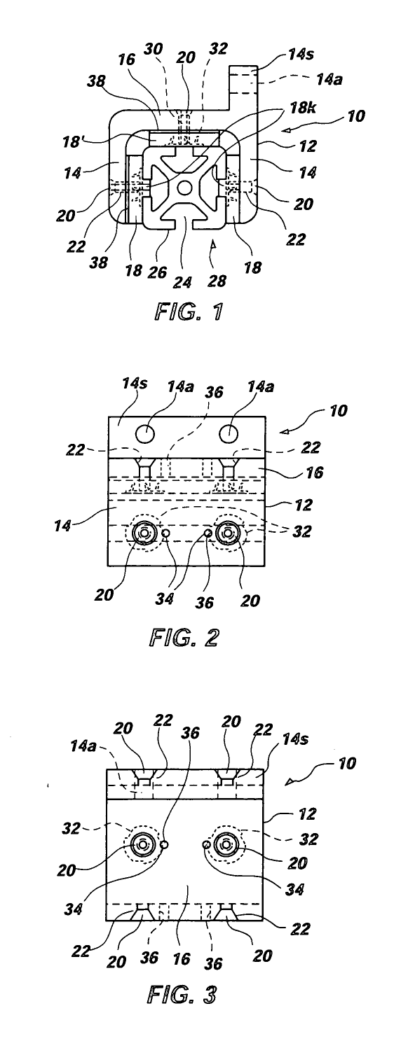

Referring to FIGS. 1 through 3 of the drawings, exemplary linear bearing assembly 10 comprises a generally U-shaped bearing slide 12 formed, for example, of aluminum and comprising two side walls 14 having an end wall 16 extending therebetween. A stub wall 14s protrudes at one side of end wall 16 and opposite a side wall 14 and includes apertures 14a therethrough for securing bearing slide 12 to another structure. Bearing pads 18 and 18′ may be formed, for example, of ultra-high molecular weight polyethylene. Bearing pads 18 and 18′ are respectively secured to vertical side walls 14 and horizontal end wall 16 using retention bolts 20, which extend through apertures 22 having frustoconical counterbores formed into the exteriors of the walls 14 and 16. Bearing pads 18 may be keyed, keys 18k extending into recesses or slots 24 extending along the sides 26 of guide rail 28, as is known in the art.

Retention bolts 20 may comprise, for example, flat head, PHILLIPS® head, or ALLEN HEAD® machine bolts or screws, the threaded ends of which are engaged with the internal threads on the bore walls 30 of tee-nuts 32 (shown in broken lines) embedded into each respective bearing pad 18 or 18′. As depicted, two retention bolts 20 may be employed to position each bearing pad 18 and 18′. Set screws 34, which may be bull-nose type, are threaded into apertures 36 in one side wall 14 and in end wall 16, although set screws 34 may be disposed in threaded apertures 36 in each side wall 14 if precise, centered alignment of guide rail 28 with respect to bearing side 12 is desired. Aluminum stiffeners or backing plates 38 to provide additional integrity to the bearing pad position may optionally be bonded to the rear faces of one bearing pad 18 and to bearing pad 18′ which are to be contacted by set screws 34, as explained further below.

In operation, when a bearing pad 18 or 18′ wears to a degree that adjustment is required to alleviate “slop” in the fit between the guide rail 28 and bearing slide 12, retention bolts 20 may be backed off to loosen the bearing pad 18 or 18′, to allow for the bearing pad 18 or 18′ to be positioned in relation to their respective wall 14 and 16 to which they are affixed. Further, the set screws 34 associated with the bearing pad 18 or 18′ may be advanced into their respective apertures 36 into contact with the rear face of the bearing pad 18 or 18′ (or with stiffener or backing plate 38 if employed), until the bearing pad 18 or 18′ is pressed snugly against the respective side 26 of guide rail 28. Retention bolts 20 may then be tightened, as required, to maintain the bearing pad 18 or 18′ in secure position against the respective side 26 of guide rail 28.

In this way, it may be appreciated that advancing set screws 34 into contact with the rear face of the bearing pad 18 or 18′ may apply a force to a bearing pad 18 of 18′ that abuts the bearing pad 18 or 18′ against the side 26 of guide rail 28. Further, it may also be appreciated that tightening the retention bolts 20 may apply a force generally oppositely to the force applied by the set screws 34 to bearing pads 18 or 18′, which may reduce the overall magnitude of force that abuts a bearing pad 18 or 18′ against an associated side of guide rail 28. Accordingly, the present invention provides a mechanism for selectively adjusting the amount or magnitude of force that holds or abuts a bearing pad 18 or 18′ against an associated side of guide rail 28. Of course, many alternatives exist for applying or adjusting forces in mechanical apparatus. For instance, threads may be used to apply or adjust forces, as may biasing elements, such as springs, mechanical bending, or other mechanisms. Accordingly, set screws 34 may comprise biasing elements, such as, for example, compression springs for applying or adjusting a force to the bearing pad 18 or 18′. In one particular example, set screws 34 may comprise a so-called spring plunger sold by Carr-Lane Manufacturing Company of St. Louis Mo.

While the present invention has been described in terms of an exemplary embodiment, those of ordinary skill in the art will understand and appreciate that many additions, deletions and modifications to the invention as disclosed herein may be made without departing from the scope thereof as recited in the following representative claims.

1. A linear bearing assembly, comprising:
a bearing slide comprising a plurality of walls defining a cavity;
a plurality of bearing pads, wherein each bearing pad is secured to a wall of the plurality with at least one retention member; and
at least one adjustment element carried by the bearing slide in cooperation with at least one bearing pad of the plurality for adjusting a position of the at least one bearing pad relative to the wall to which the at least one bearing pad is secured.

2. The linear bearing assembly of claim 1, wherein the at least one adjustment element comprises a set screw received in a threaded aperture extending through the wall to which the at least one bearing pad is secured.

3. The linear bearing assembly of claim 1, wherein the retention members comprises bolts extending through the walls of the bearing slide and into engagement with threaded bores in the bearing pads.

4. The linear bearing assembly of claim 3, wherein the threaded bores in the bearing pads are located in tee-nuts embedded in the bearing pads.

5. The linear bearing assembly of claim 1, wherein the at least one bearing pad includes a backing plate configured to provide stiffness thereto bonded to a rear face thereof.

6. The linear bearing assembly of claim 5, wherein the at least one adjustment element comprises a set screw received in a threaded aperture extending through the wall to which the at least one bearing pad is secured.

7. The linear bearing assembly of claim 6, wherein the at least one adjustment element comprises a spring plunger.

8. The linear bearing assembly of claim 1, wherein the at least one adjustment element comprises a biasing element.

9. A method of adjusting bearing pad fit in a linear bearing assembly, comprising:
providing a linear bearing assembly including at least one bearing pad secured to a wall of a bearing slide with at least one retention member;
releasing the at least one retention member to permit the at least one bearing pad to be displaced away from the wall;
advancing at least one adjustment element carried by the bearing slide to contact a rear face of the at least one bearing pad.

10. The method of claim 9, wherein the at least one retention member comprises a bolt threaded to the at least one bearing pad, and releasing the at least one retention member comprises backing off the bolt from the at least one bearing pad.

11. The method of claim 10, wherein the at least one adjustment element comprises a set screw threaded in an aperture through the wall and advancing the at least one adjustment element comprises advancing the set screw.

12. The method of claim 9, wherein the at least one adjustment element comprises a set screw threaded in an aperture through the wall and advancing the at least one adjustment element comprises advancing the set screw.

13. A method of adjusting an abutting force to a bearing pad in a linear bearing assembly, comprising:
providing a linear bearing assembly including at least one bearing pad secured to a wall of a bearing slide with at least one retention member;
providing a guide rail having a side abutting the at least one bearing pad;
applying a force to abut the at least one bearing pad against the side of the guide rail; and
selectively adjusting the force abutting the at least one bearing pad against the side of the guide rail in contact therewith by way of adjusting at least one adjustment element carried by the bearing slide to contact a rear face of the at least one bearing pad.

14. The method of claim 13, wherein selectively adjusting the force abutting the at least one bearing pad against the side of the guide rail comprises releasing at least one retention member that secures the bearing pad to a wall of the bearing slide.

15. The method of claim 14, wherein selectively adjusting the force abutting the at least one bearing pad against the side of the guide rail comprises advancing a set screw.

16. The method of claim 15, wherein selectively adjusting the force abutting the at least one bearing pad against the side of the guide rail comprises tightening the at least one retention member that secures the bearing pad to a wall of the bearing slide.

17. The method of claim 13, wherein selectively adjusting the force abutting the at least one bearing pad against the side of the guide rail comprises adjusting a biasing element.
